(19) United States
(12) Patent Application Publication
(10) Pub. No.: US 2007/0180958 A1
(43) Pub. Date: Aug. 9, 2007

(54) Multi-function screwdriver

(76) Inventors: Ronald N. Andronica, Brooklyn, NY (US); Randall C. Andronica, Brooklyn, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/581,290

(22) Filed: Oct. 16, 2006

Related U.S. Application Data
(60) Provisional application No. 60/727,083, filed on Oct. 17, 2005.

(51) Int. Cl. B25F 1/00; B25B 13/06; B25B 15/00; B25B 23/00

(52) U.S. Cl. 81/437; 81/436; 81/121.1; 81/460

(57) ABSTRACT

A screwdriver has an elongate handle and an elongate shank arranged along an axis of the handle and has one end embedded within the handle and another end provided with a driver tip configured for engaging and driving a fastener by rotating a fastener about its axis, substantially coextensive with the handle axis. An auxiliary driver in the region of the driver tip drives a fastener about an axis substantially normal to the handle axis. The handle may be provided with at least one axial elongate channel generally parallel to the handle axis dimensioned for receiving at least one driver tip when not in use. Suitable retaining member may be used for retaining the driver tips within the channel.

### CROSS REFERENCE TO RELATED APPLICATION

This application is related to and claims priority of provisional application Ser. No. 60/727,083 filed on Oct. 17, 2005.

### BACKGROUND OF THE INVENTION

1. Field of the Invention

This invention generally relates to hand tools, and, more specifically, to multi-function screwdrivers.

1. Description of the Prior Art

Screwdrivers are probably one of the oldest hand tools. However, most screwdrivers perform a single function, namely to drive a screw or other fastener into a work. More recently, multi-bit screwdrivers have been introduced which allow a user to change the tips at the end of the shank to anyone of a multitude of difference drivers for driving different fasteners. The difference driver tips may be housed in a separate housing or contained within a compartment formed inside the handle of the screwdriver and which can be selectively removed from the handle by exposing the interior of the screwdriver handle. However, although the tips themselves may be interchangeable, the uses of known screwdrivers are typically limited by their configuration, namely the size of the handle and length of the shaft, so that if a typical screwdriver has a certain overall length it may not be usable in a confined space which has a clearance only a fraction of that overall length.

### SUMMARY OF THE INVENTION

It is an object of the invention to provide a multi-function screwdriver that does not have the disadvantages of known screwdrivers.

It is another object of the invention to provide a multi-function screwdriver which is simple in construction and economical to manufacture.

It is still another object of the invention to provide a multi-function screwdriver that provides the conventional functions of a standard screwdriver and allows the driving of fasteners within a confined space that is a fraction of the dimensions of the overall length of the screwdriver.

It is yet another object of the invention to provide a multi-function screwdriver as in the previous objects which is provided on the outside surface of the handle with external axial channels or grooves for storing driver bits which are not in use.

### BRIEF DESCRIPTION OF THE DRAWINGS

The above and other objects, features and advantages of the present invention will be better understood from the following specification when read in conjunction with the accompanying drawings.

FIG. 1 is a side elevational view of a multi-function screwdriver in accordance with the present invention, broken away to illustrate the construction of a portion of the handle.

FIG. 2 is a side elevational view of the shank and driving tip of the screwdriver shown in FIG. 1, as viewed along direction A in FIG. 1.

FIG. 3 is a perspective view of an insulating sheath or sleeve for selectively covering the shank of the screwdriver shown in FIGS. 1 and 2 to provide electrical insulation for the shank.

FIG. 4 is a fragmented perspective view of a screwdriver handle provided with exterior axial channels and elastic bands for retaining driver bits within the axial channels when not in use.

FIG. 5 is a top plan view of the handle shown in FIG. 4.

FIG. 6 is a side elevantional view, partially broken away, of a handle in accordance with the invention which includes a ratcheting assembly for driving drive bits oriented at an angle substantially normal to the generally elongate axis of the handle.

FIG. 7 is a top plan view of the handle shown in FIG. 6.

FIG. 8 is a perspective view of a driver provided with a hex channel.

FIG. 9 is an enlarged cross-sectional view of the driver shown in FIG. 8.

FIG. 10 is similar to FIG. 8, but showing a square channel.

FIG. 11 illustrates a fixed hex driver provided in the handle.

FIG. 12 is a fragmented view of the tip of a screwdriver in accordance with the invention, in which a hex opening is provided in the blade tip.

FIG. 13 is a side elevational view of the screwdriver tip shown in FIG. 12, as viewed from direction B with a drive bit extending through the hex opening.

### DESCRIPTION OF THE PREFERRED EMBODIMENTS

Referring specifically to the figures, in which the same or similar parts are designated by the same reference numerals throughout, and first referring to FIG. 1, a multi-function screwdriver in accordance with the invention is generally designated by the reference numeral 5.

The screwdriver 5 includes a handle 10 which may be of conventional design and defines an axis A which also forms the axis of the screwdriver. The handle 10 may be of conventional design and ergonomically configured to be comfortable to hold during use.

In accordance with one preferred embodiment, the handle 10 is provided with a generally cylindrical recess 10a provided with an internal thread 10b. An annular recess 10c may be provided on the interior surface of the handle 10 in a conventional manner to make it more comfortable to hold the handle during use.

An elongate shank 12 is arranged along the axis A and has one end 12a embedded within the handle 10 and has another, free end 12b provided with a driver tip configured to engage and drive a fastener by rotating the fastener about an axis substantially coextensive with the handle axis A. As will be evident, the free end 12b may be fixed, as shown in FIG. 1 or may be removable and interchangeable with other tips having different driver configurations.

One important feature of the invention is the provision of auxiliary driver means for driving a fastener about an axis substantially normal to the handle axis A.

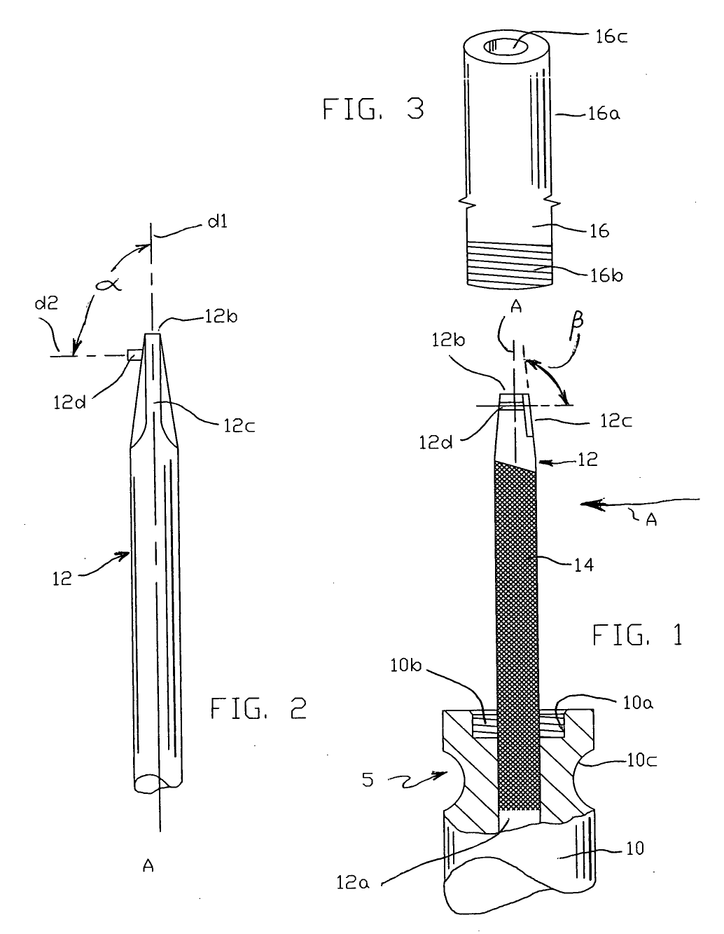

Referring to FIGS. 1 and 2, the free end 12b includes a flat blade tip with a milled edge 12c on the flat blade screwdriver tip which reduces the thickness of a lateral edge of the flat blade tip, as shown, to a dimension suitable for insertion into the head of a straight-slotted fastener. The milled tip 12c is suitable for insertion into the slot in the head of a fastener for rotating the fastener by moving the screwdriver in a plane substantially perpendicular to the axis of the fastener. When space or clearances for insertion of the screwdriver are relatively small, there are preferably provided a generally straight raised land or ridge 12d on a primary face of the flat blade tip 12b that extends in a direction generally normal to a direction of the milled lateral edge 12c. In this example shown in FIG. 1 the angle defined between the milled tip 12c and the blade tip 12b is an angle B here slightly greater than 90°. In this way, the fastener can be rotated piecemeal by first driving it with the milled edge 12c and alternating that with insertion of the raised land or ridge 12d into the fastener and rotating it with that portion of the tip.

In FIG. 1, the shank 12 is shown to be provided with a knurled surface 14 about the periphery of the shank 12 so that the shank can be used as a file. While the shank in FIGS. 1 and 2 is shown to have a circular cross-section, it should be also clear that the cross-section of the shank 12 may be any desired cross-section, such as square, oval, rectangular, triangular or the like. In each case, the knurling can be provided on the exterior surface of the shank.

Another feature of the invention is the provision of an insulating sheath 16 for selectively covering the shank 12. Preferably, suitable securing means is provided for selectively attaching the sheath 16 to the handle 10 to prevent inadvertent separation. In the presently preferred embodiment such securing means is in the form of the recess 10a in the handle at the embedded end, provided with an internal thread 10b and an external thread 16b at one end of the cylingical sleeve 16a of the sheath that can threadily meshed with the internal thread 10b. In this was, the sheath 16 may be selectively secured to the screwdriver or removed there from as the needs may require. The cross-section of the channel 16c in the insulating sheath is not critical and need only be sufficiently large and be configured to easily receive the shank 12.

The auxiliary driver provided on the screwdriver may also consist of receptacle of a bit driver instead of portions of a tip that can be received within the head of the fasteners. When a bit driver is used, the bit driver may consist of a non-circular opening on a portion of a screwdriver. Referring to FIGS. 12-13, such openings may be formed in the handle, as shown in FIG. 11, or may be formed in the driver tip as shown in FIGS. 12 and 13. The openings may be fixed opening as shown in FIGS. 12-13 or may include a clutch so that the driver is ratcheted. Regardless of whether fixed or ratcheted, the openings are preferably tapered channels to prevent a bit from fully passing through the opening.

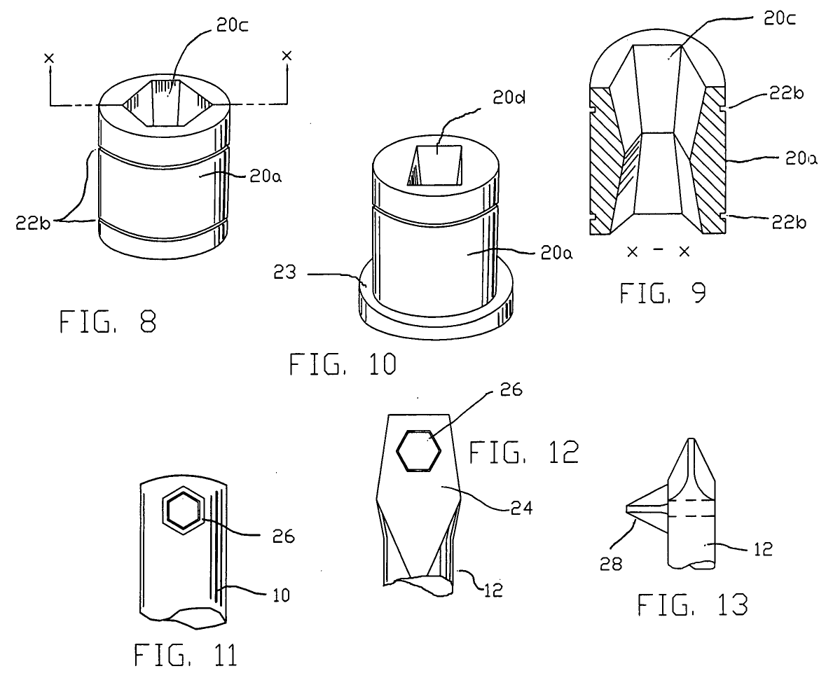

With the ratcheting assembly, the mechanism consists of an overriding roller clutch or ratcheting cartridge 20 that is pressed or force fitted or otherwise secured into a through hole or channel 18 in the handle. The specific manner in which the clutch assembly 20 is secured is not critical and may also be secured in place by any one of a number of different adhesives, such as Loctite®. The ratchet assembly is preferably placed at the rear portion of the tool handle 10. The cylindrical body 20a of the hex driver 20 has a precisely sized outside diameter and a non-round inside aperture 22c. The cylindrical body 20a of the clutch assembly 20 is secured by means of either two snap rings 22 that are accommodated into annular grooves 22b whose spacing is slightly larger then the length of the roller clutch or ratcheting assembly 20. Alternatively, the cylindrical body 20a of the clutch assembly 20 may have a ridge or flange 23 at one axial end in which case only one snap ring is necessary and needs to be employed. The internal through aperture 20c in the cylindrical body 20a of clutch assembly 20 is preferably hexagonal as shown in FIG. 8, accommodating ¼″ hexagonal inserts. Compatible bits are available with heads to drive almost any fastener such as Allen, Philips, Torx, etc.

As the roller clutch or the roller clutch assembly 20 allows rotation in only one direction it acts as a ratchet. Its direction cannot be reversed. However, to accomplish clockwise and counter-clockwise rotation it is necessary for the tool bit to be inserted into opposite axial ends of the cylindrical body or clutch assembly 20. It is also necessary that the inserted bit be held securely in the hexagonal aperture 20c of the cylindrical body. Otherwise, the bit can simply fall out due to gravity. In addition, it is also necessary that the insert should be limited as to how far it can be inserted into the aperture 20c, otherwise the insert could simply be pushed through the tool as soon as any downward pressure is applied against the insert as it engages to work. These requirements can be met by broaching the cylindrical body 20a of the clutch assembly 20 with the same orientation. Both sides are incompletely broached. As the broach is tapered, the incompletely broached part will have a tapered form. Thus, a hexagonal insert can be inserted into the cylindrical body 104 and as a result of the taper, the insert can only be inserted to a limited depth. The insert will then wedge in the tapered aperture to hold the bit securely. As the cylindrical body of the clutch assembly 20 is broached from both sides the bit can be installed from either side to allow clockwise and counter-clockwise rotation. As the cylindrical body or clutch assembly aperture 20c is a through hole a stuck driver bit can be knocked out from the other side.

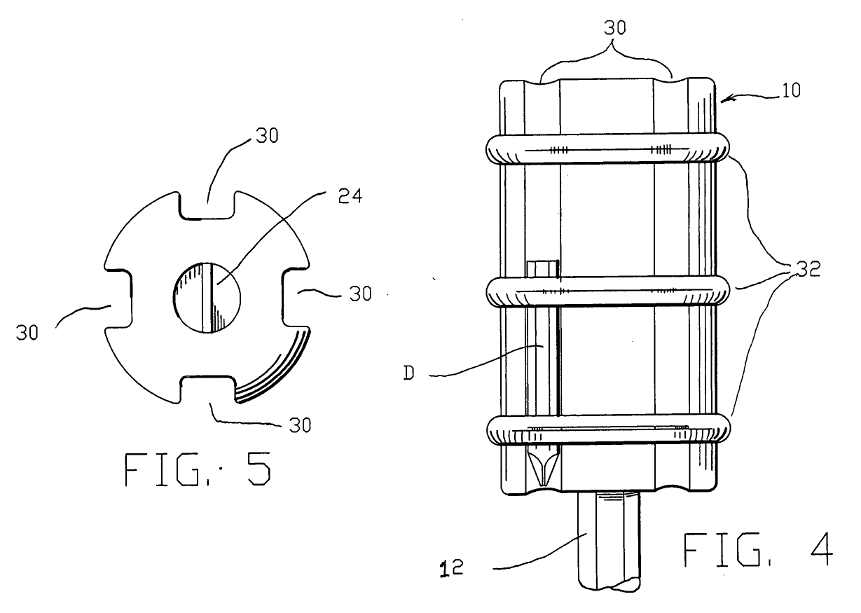

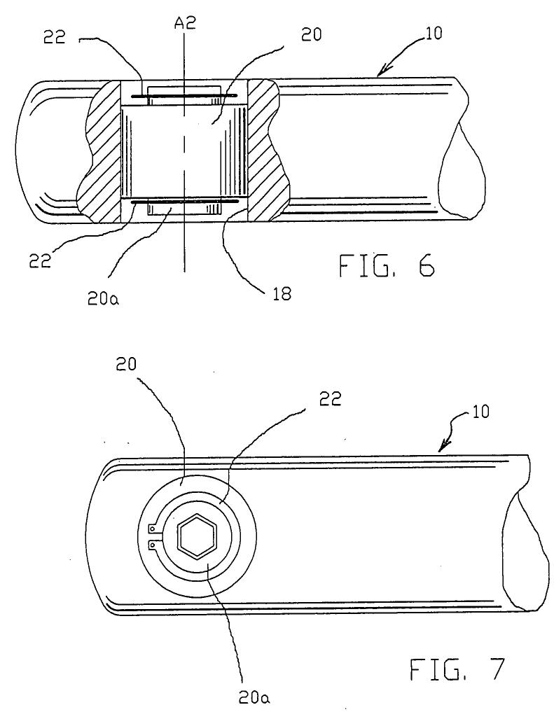

Referring to FIGS. 4 and 5, a multi-function screwdriver of the type under discussion, having interchangeable tips at the free end of the shank, may also be provided with at least one axial channel 30 generally parallel to the handle axis A and dimensioned for receiving at least one driver D when not in use. In the illustrated embodiment, a plurality of channels 30 are provided equally spaced about the circumference of the handle 10.

Retaining means is provided for retaining the driver bits D within the channels 30 to prevent inadvertent separation of the retaining driver bits when not in use. In the presently preferred embodiments, such retaining means are in the form of at least one elastic band. However, preferably, a plurality of elastic bands 32 are provided which are spaced from each other along a direction parallel to the axis A. Each of the elastic bands 32, which may be in the form of suitable rubber bands, may hold or secure driver bits at one point of contact. In FIG. 4 two such bands are shown to secure a driver tip D at two points of contact by suitably spacing the bands from each other at distances less than the overall length of the driver bit.

While the invention has been shown and described in connection with a preferred form of an embodiment it will be understood that modifications may be made without the departure from the scope or spirit of the invention.

1. A screwdriver having an elongate handle generally defining an axis; an elongate shank arranged along said axis and having one end embedded within said handle and having another end provided with a driver tip configured for engaging and driving a fastener by rotating the fastener about an axis, substantially coextensive with said handle axis, and auxiliary driver means for driving a fastener about an axis substantially normal to said handle axis.

2. A screwdriver as claimed in claim 1, wherein said auxiliary drive means comprises a milled tip on a flat blade screwdriver tip which reduces the thickness of at least one lateral edge of the flat blade tip to a dimension suitable for insertion into the slot of a straight-slotted fastener.

3. A screwdriver as claimed in claim 2, further comprising, a generally straight raised land or ridge on a primary face of the flat blade tip that extends in a direction generally normal to a direction of said milled lateral edge.

4. A screwdriver as claimed in claim 1, wherein said shank is knurled to also function as a file.

5. A screwdriver as claimed in claim 1, further comprising an insulating sheath for selectively covering said shank.

6. A screwdriver as claimed in claim 5, further comprising securing means for selectively attaching said sheath to said handle to prevent inadvertent separation.

7. A screwdriver as claimed in claim 6, wherein said securing means comprises a recess in said handle, at said embedded end, provided with an internal thread, and an externally threaded end of said sheath that can threadedly mesh with said internal thread.

8. A screwdriver as claimed in claim 1, wherein said auxiliary driver means comprises a bit driver.

9. A screwdriver as claimed in claim 8, wherein said bit driver comprises a non-circular opening on a portion of the screwdriver.

10. A screwdriver as claimed in claim 9, wherein said opening is formed in said handle.

11. A screwdriver as claimed in claim 9, wherein said opening is formed in said driver tip.

12. A screwdriver as claimed in claim 8, wherein said bit driver includes a clutch and is ratcheted.

13. A screwdriver as claimed in claim 8, wherein said bit driver is fixed.

14. A screwdriver as claimed in claim 9, wherein said opening forms a tapered channel to prevent a bit from fully passing through said opening.

15. A screwdriver having an elongate handle generally defining an axis, an elongate shank arranged along said axis and having one end embedded within said handle and having another end provided with interchanging means for selectively interchanging generally elongate driver tips, said handle being provided with at least one axial elongate channel generally parallel to said handle axis dimensioned for receiving at least one driver tip when not in use; and retaining means for retaining driver tips within said at least one channel to prevent inadvertent separation of said at least one retained driver bits.

16. A screwdriver as claimed in claim 15, wherein a plurality of channels are provided spaced about said handle.

17. A screwdriver as claimed in claim 15, wherein said retaining means comprise at least one elastic band.

18. A screwdriver as claimed in claim 17, wherein a plurality of elastic bands are provided spaced for each along a direction parallel to said axis.

19. A screwdriver having an elongate handle generally defining an axis; an elongate shank arranged along said axis and having one end embedded within said handle and having another end provided with a driver tip configured for engaging and driving a fastener by rotating the fastener about an axis, substantially coextensive with said handle axis, and auxiliary driver means for driving a fastener about an axis substantially normal to said handle axis; an insulating sheath for causing a substantial portion of said shank between said ends; and securing means for securing said sheath to said handle during use to prevent inadvertent separation.

20. A screwdriver as claimed in claim 19, wherein said securing means comprises a recess in said handle, at said embedded end, provided with an internal thread, and an externally threaded end of said sheath that can threadedly mesh with said internal thread.
